(19) United States
(12) Patent Application Publication
(10) Pub. No.: US 2010/0164177 A1
(43) Pub. Date: Jul. 1, 2010

(54) HYBRID MULTISTAGE BRUSH SEAL

(75) Inventors: Xiaoqing Zheng, East Greenwich, RI (US); Joshua J. Duquette, Coventry, RI (US)

Correspondence Address: DYKEMA GOSSETT PLLC, 39577 WOODWARD AVENUE, SUITE 300, BLOOMFIELD HILLS, MI, 48304-5086, US

(73) Assignee: Eaton Corporation, Cleveland, OH (US)

(21) Appl. No.: 12/345,881

(22) Filed: Dec. 30, 2008

(51) Int. Cl. F16J 15/44

(52) U.S. Cl. 277/355

(57) ABSTRACT

A multi-stage brush seal and assembly for sealing a circumferential gap with respect to a sealed component is disclosed. The brush seal includes a first stage including a first plurality of bristles and a second stage including a second plurality of bristles. In an embodiment, the first stage is configured with an initial first-stage clearance and seals said sealed component at high pressure and low pressure conditions, and the second stage is configured to have an initial second-stage clearance greater than the initial first-stage clearance so that the second stage does not seal said sealed component at the low pressure condition but is configured to be activated by a blow-down effect to seal said sealed component at the high pressure condition. In embodiments the brush seal includes features to enhance or reduce pressure blow-down with respect to the first-stage clearance.

### TECHNICAL FIELD

The present invention generally relates to multi-stage brush seals for providing a seal, including brush seals that provide circumferential seal between two machine components in varying pressure conditions.

### BACKGROUND

Brush seals in aircraft engines experience different operating conditions at different stages of flight. For example, during aircraft take-off, the brush seal must be able to handle large pressure loading at high speed and high temperature. In a cruising condition, there is relatively little pressure across the seal, but the speed may remain high. Heat from rubbing friction may overheat the bristles because the leakage is insufficient to cool off the bristles. Lab tests indicate the seal temperature may spike several hundred degrees at high speed and low-pressure conditions. However, if the seal allows enough leakage at low pressure conditions, it usually will leak too much at high pressure conditions. Leaking too much at high pressure conditions means reduction of temperature margin for the engine, and may require immediate maintenance. Under high pressure differential, the leakage is sufficient to cool of the bristles of the brush seal. Therefore, leakage at high pressure conditions should be kept to a minimum. But at low pressure conditions, such as where the pressure difference is less than 40 psid, more air leakage should be allowed to keep the bristle pack cool for some high speed engines. Therefore, the brush seal for an aircraft engine must seal well at high pressure conditions but also should permit adequate air leakage to keep the bristles cool at low pressure differentials.

It is therefore desirable to provide a seal that is sufficiently tight at high pressure conditions and is sufficiently loose at low pressure conditions.

### SUMMARY

A multi-stage brush seal and assembly for sealing a circumferential gap with respect to a sealed component is disclosed. The brush seal includes a first stage including a first plurality of bristles and a second stage including a second plurality of bristles. In an embodiment, the first stage is configured with an initial first-stage clearance and seals said sealed component at high pressure and low pressure conditions, and the second stage is configured to have an initial second-stage clearance greater than the initial first-stage clearance so that the second stage does not seal said sealed component at the low pressure condition but is configured to be activated by a blow-down effect to seal said sealed component at the high pressure condition.

In embodiments the brush seal includes features to enhance or reduce pressure blow-down with respect to the first-stage clearance. For example, without limitation, the first stage may include a back plate having features to enhance or reduce the effects of pressure blow-down.

### BRIEF DESCRIPTION OF THE DRAWINGS

Embodiments of the invention will now be described, by way of example, with reference to the accompanying drawings, wherein:

FIG. 1 is a top plan view of a brush seal according to an embodiment of the invention;

FIG. 2 is schematic cross sectional elevation view of a brush seal in accordance with teachings of the present invention; and

FIG. 3 is a graph of leakage versus pressure for several multi-stage brush seals.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

Brush seals provided in connection with embodiments of the invention may be described as multistage brush seals. Multistage brush seals in accordance with teachings of the present invention may be configured to have a small effective clearance in high pressure conditions and, conversely, have a large effective clearance in low pressure conditions. The “effective clearance” is a measure of the brush seal leakage control capability, which is an equivalent gap size of an annular clearance of a same diameter that leaks the same amount under the same pressure and temperature conditions. That is, the larger the gap, the greater the amount of leakage.

In an embodiment of the invention, the brush seal employs a blow-down design configuration for one or more front stages on the upstream high-pressure side, and a gapped or blow-down-resistant design for one or more rear stages provided toward or close to the downstream low pressure side of the seal. The front stage (or stages) may be configured to seal well at both high pressure and low pressure conditions. The rear stage (or stages) starts with a clearance so that it will not seal at low pressure conditions, but will seal at high pressure conditions because the bristles will close in due to the blow-down effect at high pressure differential conditions. The pressure at which the blow-down takes place is effected by the initial clearance and can be further controlled by adding other features such as spiral or slant grooves on a backplate to enhance or reduce pressure blow-down so as to trigger early or late transition from open to close of the initial clearance.

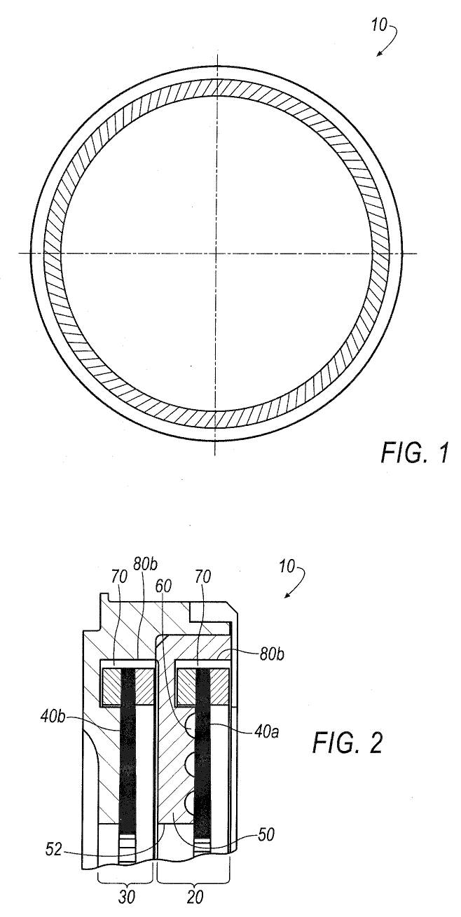

FIG. 1 illustrates a top plan view of an embodiment of a hybrid brush seal 10 in accordance with teachings of the present invention. FIG. 2 provides a cross-sectional view of the brush seal 10 of the type shown in FIG. 1, which may be described as a two-stage or multistage brush seal. However, it is noted that the invention is not necessarily limited to a two-stage brush seal configuration and other configurations, such as those that include more than two front stages and/or more than two rear stages, are also contemplated by the invention.

As generally illustrated in FIG. 2, the seal 10 includes a front stage 20 and a rear stage 30, each stage including a plurality of bristles (or a bristle pack). The bristles associated with the front stage are identified as 40a, while the bristles associated with the rear stage are identified as 40b. The bristles utilized may be of any type and form suitable for providing an intended sealing function. In an embodiment, the front stage 20 is configured to seal a component (e.g., a rotating shaft) at both high pressure and low pressure conditions.

The rear stage 30 is configured to start with an initial (free state) clearance so that is not intended to seal at low pressure conditions. However, the rear stage 30 may be configured to seal at high pressure such that at high pressure the bristles 40b will close in on the component being sealed by virtue of the blow-down effect caused by the high pressure condition. The pressure at which the blow-down (and associated rear stage sealing) occurs is affected by the initial clearance and can be further modified or controlled with the inclusion of one or more other features. For example, without limitation, the back plate 50 may include formations—such as the illustrated grooves 60 (which may, for example, be spiral or slanted)—to modify (e.g., enhance or reduce) pressure blow-down. A modified pressure blow-down can, among other things, be employed to trigger an earlier or later transition from an opening to a closing of the initial clearance associated with the rear stage 30. For example, without limitation, where spiral grooves and/or slant are included in the back plate 50, high pressure can be driven down to the inner diameter 52 of the back plate 50. It is noted that the number and dimensions of the grooves 60 in the back plate 50 can vary depending upon the desired effect.

Referring again to FIG. 1, an embodiment of a hybrid brush seal 10 in accordance with teachings of the present invention is shown. In the illustrated two-stage brush seal 10 the front stage 20 includes an example of a blow-down modified/enhanced design. In the illustrated embodiment, the front stage 20 has an initial line-to-line or small interference with the sealed component—e.g., a runner or shaft (not shown)—to which the front stage 20 interacts/seals. In the illustrated seal 10, spiral grooves 60 wind inwardly in the direction against the lay angle of bristles 40a. The leakage flow within the spiral groove 60 and the pressure gradient will force (i.e., push) the bristles 40a against the sealed component (e.g., the associated runner or shaft) and the front stage 20 will consequently provide a tight seal.

In contrast the rear stage 30 is configured to provide an initial clearance relative to the sealed component. In an embodiment, the rear stage 30 may provide an initial (free state) clearance of about 0.010 to about 0.020 inches between the bristle tips and the sealed component (e.g., runner or shaft).

It is noted that, as shown in the illustrated embodiment, a radial clearance 70 may be provided with respect to both the front and rear stages 20 and 30. The radial clearance 70 can provide a space above the bristles (40a and/or 40b) between respective radial housing portions (80a and 80b) to permit some amount of radial movement of the bristles. Such a configuration can be coordinated in connection with anticipated pressures and help reduce wear. Also, while the front and rear stages 20 and 30 are shown substantially adjacent one another (see, e.g., FIG. 2), for some applications additional spacing between the stages can be provided.

At low pressure differential conditions, only the front stage 20 is performing a sealing function. Under higher pressure differential conditions, both stages 20 and 30 will seal and will share the pressure loading. With such a configuration, only the front stage 20 is running in contact with the sealed component (runner/shaft) under low pressure differentials so that less heat is generated. That enables the majority of the friction heat to be taken away by the small leakage. At high pressure differential conditions (where blow-down occurs), there are more than sufficient leakages to cool the bristles. As such, the seal can be configured so that the temperatures of the bristles and the sealed component are under control even though both the front and rear stages 20, 30 are running in contact with the sealed component.

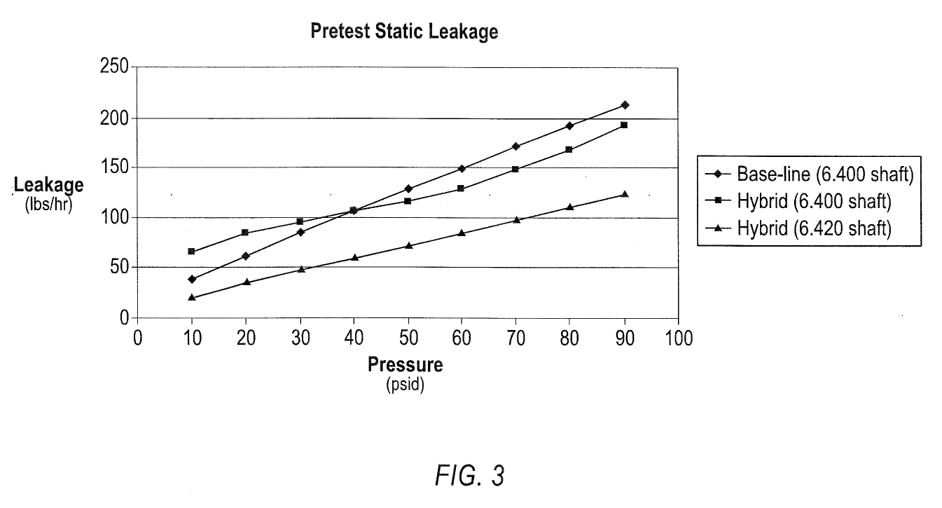

As generally shown in the chart included in FIG. 3, it was noticed that the hybrid seal leaks much more than a conventional two-stage brush seal at lower pressure differentials, for example, when the pressure difference is less than about 30 psid. Then at some point, with an increased pressure differential (e.g., about 40 psid in the instant chart), the rear stage 30 is activated by pressure blow-down. Then, at about that point, the hybrid seals leak less than a conventional two-stage brush seal. Also, as generally illustrated in the chart, the leakage of the novel hybrid seal when the runner/shaft has a diametrical growth of 0.020 inches. For embodiments, this can signify an outer boundary (or maximum) closure condition. The leakage is significantly reduced when both the front and rear stages 20, 30 are engaged.

Moreover, as noted, in embodiments the seal can provide less leaking at high pressure differences with the inclusion of blow-down enhanced features—such as those associated with the back plate 50. Grooves, such as spiral grooves 60, can provide for a better pressure balance and keep the bristles following the sealed surface. Further, initial rig tests have demonstrated improved wear characteristics with some blow-down enhanced designs. That is, the configuration has been found to provide improved sealing with less wear.

It is noted that there can be reasons, including heat management issues under low pressure conditions, for not selecting the same design for both the front and rear stages. That is, for some embodiments if both stages employ a low-leakage design, the heat generated by the two stages will flow into the sealed component and the brush seal. Heating up the sealed component could promote or induce rotordynamic instability, and overheating of the bristles could affect the bristle materials properties (i.e., tribological properties) and lead to increased/premature wear—which can also be a problem associated with conventional brush seals.

With such configurations as described above, the present invention can, inter alia, provide a seal that employs one stage for low pressure conditions and both stages at high pressure conditions. This is in contrast with conventional multi-stage brush seals, in which each stage is essentially the same except that different clearances are used to put more loading on the front stage. However, even if those stages are made to have different clearances, as the seal wears, the clearances of the different stages will no longer keep the desired proportion. As such, the balance of pressure loading will eventually be lost. Embodiments of the present invention can provide enhanced sealing capability—even as the seal wears.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims appended hereto and their equivalents.

What is claimed is:

1. A multi-stage brush seal for sealing a circumferential gap with respect to a sealed component, the brush seal comprising:
a first stage including a first plurality of bristles, the first plurality of bristles having free ends extending in a direction toward said sealed component; and
a second stage including a second plurality of bristles, the second plurality of bristles having free ends extending in a direction toward said sealed component;
wherein the first stage is configured with an initial first-stage clearance with respect to said sealed component and the first stage seals said sealed component at a high pressure and a low pressure condition; and the second stage is configured to have an initial second-stage clearance with respect to said sealed component that is greater than the initial first-stage clearance so that the second stage does not seal said sealed component at the low pressure condition but is configured to be activated by a blow-down effect to seal said sealed component at the high pressure condition.

2. The brush seal according to claim 1, wherein the first-stage initial clearance is a line-to-line or small interference clearance.

3. The brush seal according to claim 1, wherein the second-stage initial clearance is within a range from about 0.010 to about 0.020 inches.

4. The brush seal according to claim 1, wherein the first stage includes a means for enhancing or reducing pressure blow-down with respect to the first-stage clearance.

5. The brush seal according to claim 1, wherein the first stage includes a back plate, the back plate including one or more grooves configured to enhance or reduce pressure blow-down with respect to the first-stage clearance.

6. The brush seal according to claim 5, wherein the one or more grooves comprise a spiral or a slant groove.

7. The brush seal according to claim 1, including two or more first stages.

8. The brush seal according to claim 1, including two or more second stages.

9. The brush seal according to claim 1, wherein said sealed member is a runner or rotating shaft.

10. The brush seal according to claim 1, wherein a radial clearance is provided between the first plurality of bristles and a portion of a housing on the opposite side of the bristles from that configured to contact said sealed component; and a radial clearance is provided between the second plurality of bristles and a portion of a housing on the opposite side of the bristles from that configured to contact said sealed component.

11. The brush seal according to claim 1, wherein the brush seal employs a blow-down design configuration for the first stage on an upstream high-pressure side, and a gapped or blow-down-resistant design for the second stage positioned closer to a downstream low pressure side of the brush seal.

12. A multi-stage brush seal assembly for sealing a circumferential gap with respect to a sealed component, the brush seal comprising:
a housing configured to receive a first stage and a second stage;
a first stage including a first plurality of bristles, the first plurality of bristles having free ends extending in a direction toward said sealed component; and
a second stage including a second plurality of bristles, the second plurality of bristles having free ends extending in a direction toward said sealed component;
wherein the first stage is configured with an initial first-stage clearance with respect to said sealed component and the first stage seals said sealed component at a high pressure and a low pressure condition; the second stage is configured to have an initial second-stage clearance with respect to said sealed component that is greater than the initial first-stage clearance so that the second stage does not seal said sealed component at the low pressure condition but is configured to be activated by a blow-down effect to seal said sealed component at the high pressure condition; a radial clearance is provided between the first plurality of bristles and a portion of the housing; and a radial clearance is provided between the second plurality of bristles and a portion of the housing.

13. The brush seal according to claim 12, wherein the first stage includes a back plate provided adjacent the first plurality of bristles.

14. The brush seal according to claim 13, wherein the back plate includes one or more grooves configured to enhance or reduce pressure blow-down with respect to the first-stage clearance.

15. The brush seal according to claim 14, wherein the one or more grooves comprise a spiral or slant groove.
